(19) United States
(12) Patent Application Publication
(10) Pub. No.: US 2023/0021304 A9
(43) Pub. Date: Jan. 19, 2023

(54) Fishing Device

(71) Applicant: Mark and Shannon Cure, Grove, OK (US)

(72) Inventor: Mark Cure, Grove, OK (US)

(21) Appl. No.: 17/097,372

(22) Filed: Nov. 13, 2020

Related U.S. Application Data
(60) Provisional application No. 63/004,552, filed on Apr. 3, 2020.

(51) Int. Cl. A01K 91/04; A01K 91/047

(52) U.S. Cl. CPC A01K 91/04; A01K 91/047

(57) ABSTRACT

A device and method of use with a weighted portion with two or more barrel swivels affixed to the weighted portion for the purpose of fishing. A device to mitigate the twisting and/or damage to the fishing line. A device with a weighted portion, a hook portion, a bait keeping portion, and two or more barrel swivels to affix a second fishing device to hang below the main device in order to either catch an additional fish at the same time or to give a single fish another option.

### BACKGROUND

### Field of Use

This device is to be used to assist in catching fish. The preferred embodiment of the device allows for the user to create a greater potential for catching fish by being able to have two hooks set upon the same line. In its most basic form the device can mitigate the twisting of the line decreasing the potential for damage to the fishing line.

### Background of Prior Art

Humans typically catch fish using a hook attached to a string or line. To get the line and the hook to sink into the water to a location where fish are located, a weight is typically attached along the line above the hook to aid in sinking the weight.

There are times when the weight, also called a sinker, moves up and down the line, or even causes the line to weather or break when the line is under stress, for instance when a thrashing fish is on the line. If the line breaks while a fish is hooked then the rigging and the fish are lost.

Another problem of having a separate weight on the line is the fish biting at the weight and not at the hook. Fish will also be curious and bite or nibble at the stand-alone weights instead of the hook and thus decreases the likelihood of catching a fish.

The current types of fishing lures that allow fishermen to use a double jig have several problems. The main issue being the twisting and tangling of the line, which can be a nightmare of frustration for a fishermen.

The design of current devices that allow for a double jig have points from attaching the lure to the line, these points are fixed and are not meant to move. This fixed point can create a tangled mess of the lures and line and a twisting of and stress upon the line.

Even a single hook attached to the line at a fixed point can create a twisting of the line and create wear and tear to the line, weakening the line and increasing the potential for the line to break. The breaking of the line, especially once a fish is attached to the hook attached to the line, is a major problem and counterproductive when the object of fishing is to catch and reel in the fish.

Tying loop knots and other difficult knots to secure a lure to the fishing line is time consuming and are typically improperly done, often causing the line to break or the lure or rig to fall off of the line.

Additional weights and sinkers damage the line, can create another point for the line to tangle, and can result in loss of the caught fish, the lure, or both.

Having a device which the line attaches to a point that is not fixed, but rotates can significantly reduce the potential for damage to the line from twisting. And having a type of device that can also allow for two hooks to be attached to the same line of the fishing pole can potentially double the chance of catching a fish.

### DESCRIPTION

Disclosed herein is a device that mitigates the twisting of the line by the use of a barrel swivel at the point of attachment to the fishing line. Disclosed herein, is a device that allows for the use of a double rig when fishing. The preferred embodiment of this device comprises two barrel swivels incorporated into the weighted portion of the device at approximately 180 degrees from one another. One version of the preferred embodiment of the device comprises the hook portion being at a 90 degree angle to the barrel swivels. Another version of the preferred embodiment of the device comprises the hook portion being at a 40 degree angle to one of the barrel swivels.

All elements of the device can be modified to varying sizes and weights to be directed to catching fish of all sizes.

As used herein, the term “weight” or “weighted portion” refers to the element of the device that enables the device to sink down into the water. It is also referring to the portion of the device to which the barrel swivels are attached as well as to where the hook and bait keeping portion are also affixed.

The invention relates generally to devices for catching fish of any size with a line and in most cases a fishing pole.

Examples of alternative embodiments of the device are the different types of hook sizes, weight sizes and sizes of barrel swivels adapted to catching various sizes and types of fish.

It is an object of the present invention to catch fish of any size or type.

It is an object of the present invention to allow for two points on the same line to catch fish.

It is an object of the present invention to mitigate line breakage.

It is an object of the present invention to mitigate twisting of the line and tackle.

It is an object of the present invention to increase the likelihood of catching a fish.

In its most complete form the device comprises: 1) a weighted portion; 2) two barrel swivels; with optional 3) a hook portion; and 4) an optional bait keeping portion. In its most complete form the device comprises two barrel swivels to enable a second device to be attached below the device.

Although the invention has been described in detail with reference to several embodiments additional variations and modifications exist within the scope of the spirit of the invention as described.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

### DESCRIPTION OF THE DRAWINGS

The following reference numbers correspond to the drawings:

10 Fishing device

12 Weighted portion

14a and 14b Barrel swivels

16 Hook portion

18 Bait keeping portion

FIG. 1 shows the device 10 with both barrel swivels 14 affixed to the weighted portion 12, a hook portion 16 and a bait keeping portion 16 also affixed to the weighted portion 12. In FIG. 1, the hook 16 and bait keeping portions 18 are affixed to the weighted portion 12 to create a 90 degree angle to the barrel swivel 14a and 14b.

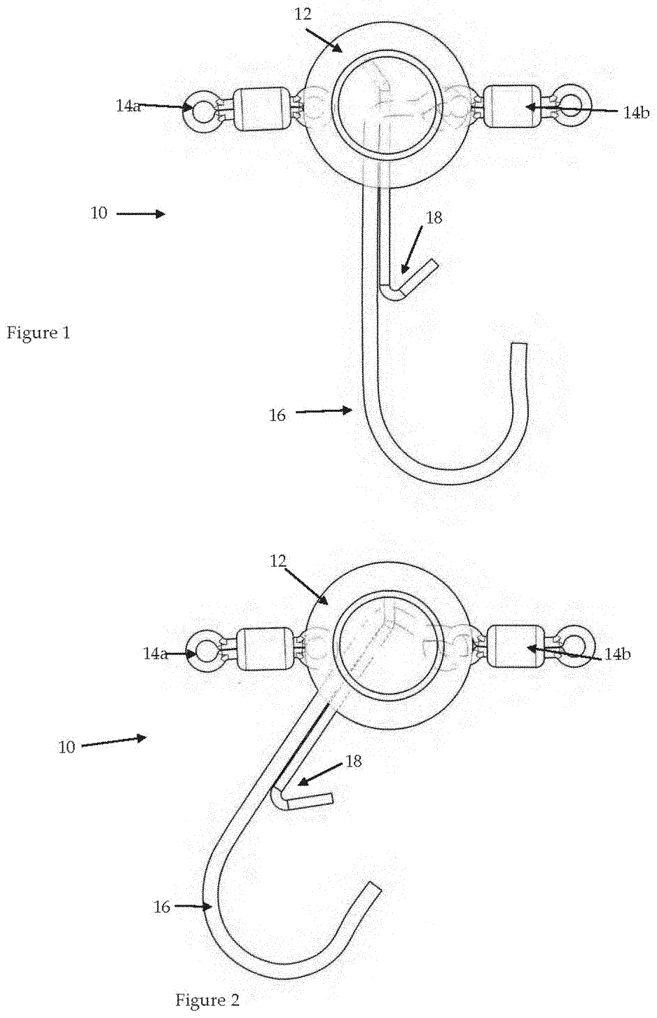

In FIG. 2, the device 10 has one difference, the hook 16 and bait keeping portions 18 are affixed to the weighted portion 12 to create approximately a 40 degree angle to the barrel swivel 14a and approximately a 140 degree angle to barrel swivel 14b.

FIG. 3 shows the barrel swivel 14.

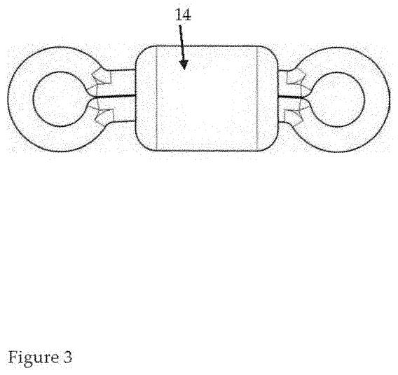

FIG. 4 shows the bait keeping portion 18 at several different angles and lengths.

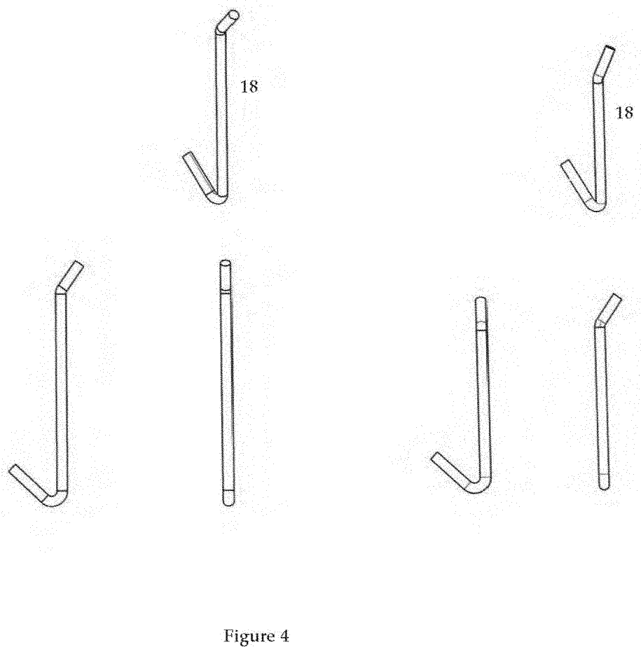

FIG. 5 shows an environmental view of the device 12 being attached to a fishing pole with a jig head attached to one of the barrel swivels 14a.

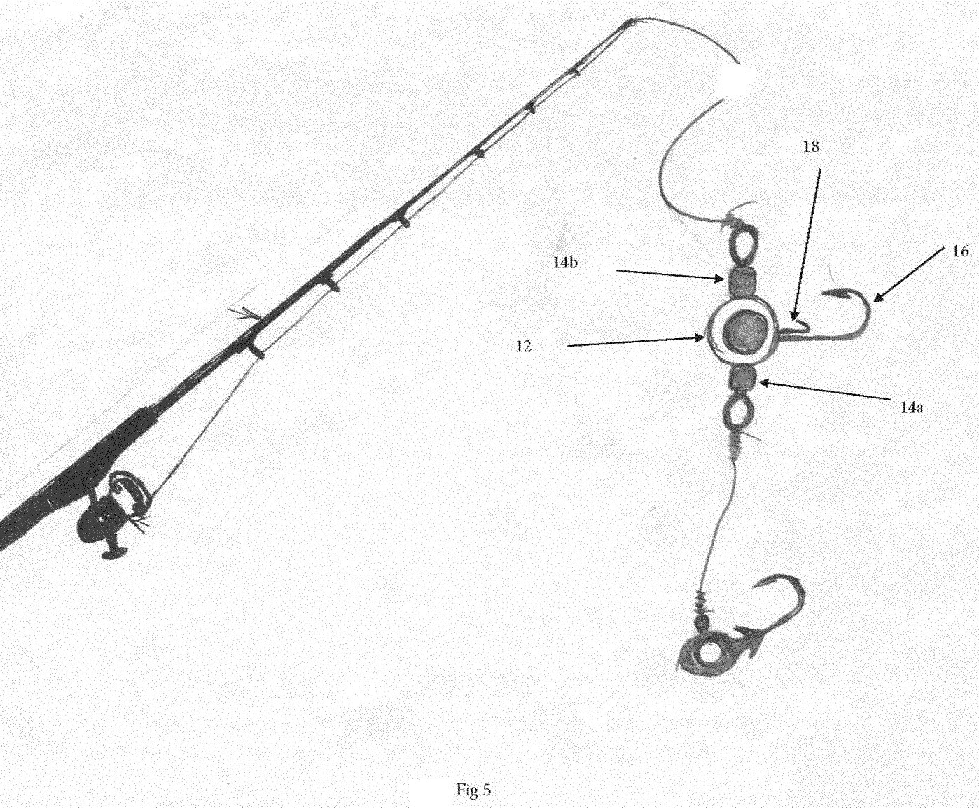

What is claimed is:

1. A device for catching fish comprising:
A weighted portion,
A hook portion;
A bait keeping portion; and
two or more barrel swivels
wherein said two or more barrel swivels are affixed to said weighted portion.

2. (canceled)

3. (canceled)

4. The device of claim 1, wherein said weighted portion, with two said barrel swivels, is affixed to said hook portion to create an approximately 90 degree angle to said barrel swivels.

5. The device of claim 1, wherein said hook portion is affixed to said weighted portion to create approximately a 40 degree angle to first said barrel swivel and approximately a 140 degree angle to second said barrel swivel.

6. The device of claim 1, wherein a second fish catching device is attached to one of said two or more barrel swivels such that said second fish catching device is positioned below the device of the claim 1.
